(19) United States
(12) Patent Application Publication
(10) Pub. No.: US 2014/0191752 A1
(43) Pub. Date: Jul. 10, 2014

(54) Spectral Decomposition Of Composite Solid State Spin Environments Through Quantum Control of Spin Impurities

(71) Applicants: Ronald Walsworth, Newton, MA (US); Linh My Pham, Cambridge, MA (US); Nir Bar-Gill, Cambridge, MA (US); Chinmay Belthangady, Cambridge, MA (US)

(72) Inventors: Ronald Walsworth, Newton, MA (US); Linh My Pham, Cambridge, MA (US); Nir Bar-Gill, Cambridge, MA (US); Chinmay Belthangady, Cambridge, MA (US)

(73) Assignee: President And Fellows Of Harvard College, Cambridge, MA (US)

(21) Appl. No.: 14/125,941

(22) PCT Filed: Jun. 13, 2012
(86) PCT No.: PCT/US2012/042317

§ 371 Date: Mar. 18, 2014

Related U.S. Application Data
(60) Provisional application No. 61/496,521, filed on Jun. 13, 2011.

(51) Int. Cl. G06N 99/00

(52) U.S. Cl. CPC G06N 99/00
USPC 324/300

(57) ABSTRACT

Methods and systems are described for spectral decomposition of composite solid-state spin environments through quantum control of electronic spin impurities. Δ sequence of spin-control modulation pulses are applied to the electronic spin impurities in the solid-state spin systems. The spectral content of the spin bath that surrounds the electronic spin impurities within the solid-state spin system is extracted, by measuring the coherent evolution and associated decoherence of the spin impurities as a function of number of the applied modulation pulses, and the time-spacing between the pulses. Using these methods, fundamental properties of the spin environment such as the correlation times and the coupling strengths for both electronic and nuclear spins in the spin bath, can be determined.

### CROSS-REFERENCE TO RELATED APPLICATIONS

The present application is based upon, and claims the benefit of priority under 35 U.S.C. §119, to co-pending U.S. Provisional Patent Application No. 61/496,521 (the “'521 provisional application”), filed Jun. 13, 2011 and entitled “Spectral Decomposition of Solid-State Spin Environment Through Quantum Control of Spin Impurity.” The content of the '521 provisional application is incorporated herein by reference in its entirety as though fully set forth.

### STATEMENT REGARDING FEDERALLY SPONSORED RESEARCH

This invention was made with government support under contract number 60NANB10D002 awarded by NIST (National Institute Of Standards And Technology). The government has certain rights in the invention.

### BACKGROUND

Understanding and controlling the coherence of multi-spin-qubit solid-state systems is crucial for applications such as quantum information science, quantum many-body dynamics, and quantum sensing and metrology. Examples of multi-spin-qubit solid-state systems include, without limitation, nitrogen-vacancy (NV) color centers in diamond, phosphorous donors in silicon and quantum dots.

These systems require the maintaining of long coherence times, while increasing the number of qubits available for coherent manipulation. For solid-state spin systems, qubit coherence is closely related to fundamental questions relating to many-body spin dynamics.

There is a need to better understand these questions, which include questions relating to the sources of decoherence in the multi-spin solid state systems and their interplay with qubit density, and to the interaction of the spin qubits with the spin bath environment.

### BRIEF DESCRIPTION OF THE DRAWINGS

The drawings disclose illustrative embodiments. They do not set forth all embodiments. Other embodiments may be used in addition or instead.

FIG. 1A is a schematic block diagram of a system for extracting information about the spectral content and dynamics of the spin bath surrounding spin impurities in a solid state spin system, in one embodiment of the present disclosure.

FIG. 1B illustrates the use of the CPMG pulse sequence used to perform spectral decomposition measurements with the system of FIG. 1B.

FIG. 2A shows the lattice structure of diamond with an NV color center.

FIG. 2B shows the magnetic environment of the NV center electronic spin, resulting from the ¹³C nuclear spin impurities and the N (nitrogen) electronic spin impurities.

FIG. 3A illustrates the Hahn-Echo and the multi-pulse (CPMG) pulse sequences.

FIG. 3B illustrates the electronic energy level structure of a negatively charged NV center.

FIG. 4 illustrates calculated F_{ω}^{CPMG} filter functions, for different values of the number n of CPMG pulses: n=1, 64, and 128.

FIG. 5A shows examples of measured NV multi-spin coherence as a function of time, C(t), for CPMG pulse sequences with different numbers of pulses n.

FIG. 5B illustrates the scaling of T₂ with the number n of CPMG pulses, as derived from NV spin coherence decay data Cₙ(t).

FIG. 6 compares the measured NV multi-spin coherence as a function of time Cₙ(t) for CPMG pulse sequences with different numbers of pulses n, with corresponding synthesized curves calculated using the average-fit Lorentzian spin bath spectrum.

### DETAILED DESCRIPTION

Illustrative embodiments are discussed in this disclosure. Other embodiments may be used in addition or instead.

The present invention is not limited to the particular embodiments described, as such may of course vary. The terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

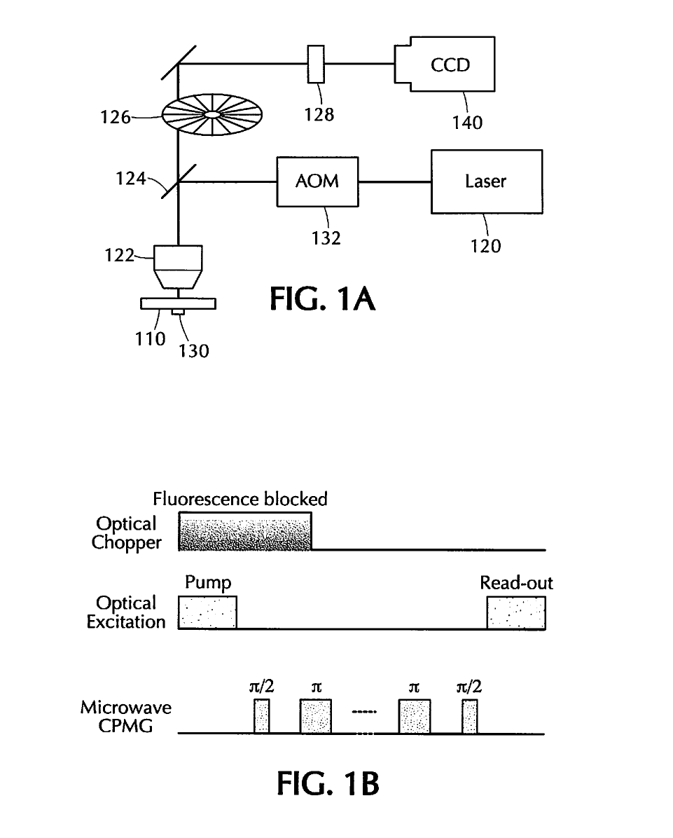

FIG. 1A is a schematic block diagram of a system 100 for extracting information about the dynamics of a spin bath surrounding spin impurities in a solid state spin system, in one embodiment of the present disclosure. In the illustrated embodiment, the system 100 is a wide-field fluorescence microscope. In overview, the system 100 includes a microwave pulse generator 130 that generates spin-control modulation pulses; an optical source 120; and a detector 140.

The microwave source 130 may be a loop antenna, in one embodiment. The loop antenna 130 may be positioned near the diamond surface and connected to the amplified output of a microwave signal generator, to generate a homogeneous B₁ field over the region of interest. Fast-switching of the microwave field allows for coherent manipulation of the NV spin states, as is necessary for coherence decay measurements using the modulation pulses (for example CPMG pulse sequences), in order to perform spectral decomposition.

In the illustrated embodiment, the optical system 120 is a laser tunable to produce 532 nm light, which is switched by an acousto-optic modulator (AOM) 132, and is directed through a dichroic mirror 124 and an objective 122 onto a diamond sample 110. The fluorescence from the sample 110 passes through the dichroic mirror 124 and, following an optical chopper 126 and filters 128, is collected by a detector 140. While in the illustrated embodiment, the detector 140 is a charge-coupled device (CCD), any other type of optical fluorescence detectors can be used in other embodiments, including without limitation photodiodes. Electronic spin polarization and readout is performed by optical excitation at 532 nm and red fluorescence detection. Ground-state spin manipulation is achieved by resonant microwave excitation by a microwave source 130.

The AOM 132 may act as an optical switch, to pulse the laser with precise timing in order to prepare and detect the NV spin states. By way of example, one model of an AOM that can be used is Isomet M1133-aQ80L-H.

In some embodiments, optical and microwave pulse timings may be controlled through a computer-based digital delay generator (for example a SpinCore PulseBlaster PRO ESR500). NV fluorescence may be collected by the objective, filtered, and imaged onto a cooled charge-coupled device camera (Starlight Xpress SXV-H9). As the duration of a single measurement is shorter than the minimum exposure time of the camera, the measurement may be repeated for several thousand averages within a single exposure and syncronized to an optical chopper placed before the camera in order to block fluorescence from the optical preparation pulse. Repeating the measurement without the microwave control pulses may provide a reference for long-term drifts in the fluorescence intensity.

Δ processing system may be integrated with the system 100 described in FIG. 1A. The processing system is configured to control the optical and microwave pulse timings, as described above. The processing system is configured to implement all other methods, systems, and algorithms, as further described below in the present application. The processing system may include, or may consist of, any type of microprocessor, nanoprocessor, microchip, or nanochip.

The processing system may be selectively configured and/or activated by a computer program stored therein. It may include a computer-usable medium in which such a computer program may be stored, to implement the methods and systems described above. The computer-usable medium may have stored therein computer-usable instructions for the processing system. The methods and systems in the present application have not been described with reference to any particular programming language; thus it will be appreciated that a variety of platforms and programming languages may be used to implement the teachings of the present application.

FIG. 1B illustrates the use of a CPMG pulse sequence to perform spectral decomposition measurements, using the system of FIG. 1A. As illustrated in FIG. 1B, in operation optical pulses are used to first initialize the NV and then to readout its spin state. The optical chopper is synched such that the initialization pulse is blocked from the CCD, while the readout pulse is recorded. The microwave pulses are applied between the initialization and readout optical pulses.

While a CPMG pulse sequence is shown in FIG. 1B, in other embodiments different types of pulse sequences, including without limitation n-pulse XY sequences, can be use to perform spectral decomposition measurements described in this application.

In some embodiments, during these measurements the loop of wire 130 may deliver 3.07 GHz MW pulses to the sample, resonant with the NV mₛ=0 to mₛ=±1 spin transition for the applied static magnetic field∓70 G, to manipulate the NV spin coherence and implement CPMG spin-control pulse sequences.

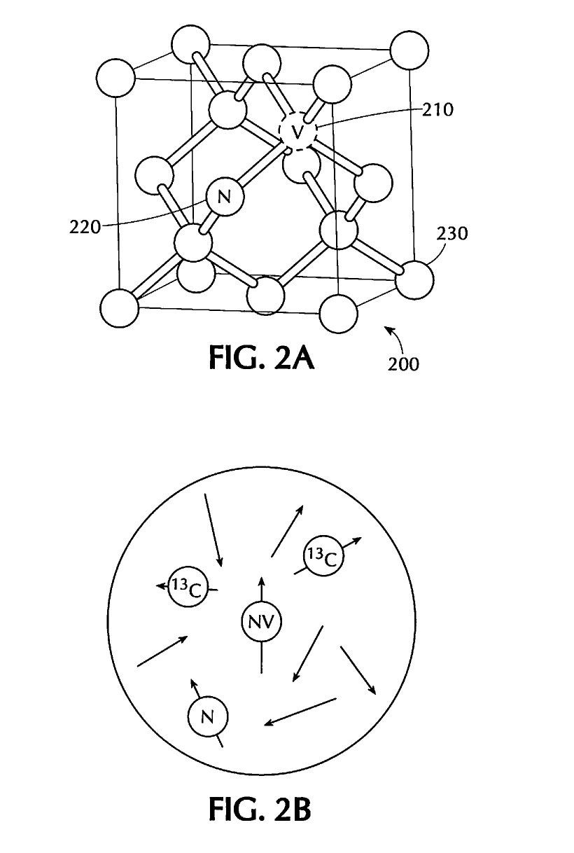

FIG. 2A shows the lattice structure of diamond with an NV color center. The NV electronic spin axis is defined by nitrogen and vacancy sites, in one of four crystallographic directions in the diamond lattice. NV orientation subsets can be spectrally selected by applying a static magnetic field B₀.

FIG. 2B shows the magnetic environment of the NV center electronic spin, from the ¹³C nuclear spin impurities and the N (nitrogen) electronic spin impurities. Interactions between the NV spin and its environment comprising of Nitrogen (N) electronic and Carbon (¹³C) nuclear spins causes dephasing and reduces T₂. In the weak coupling limit, the bath can be modeled as a semi-classical fluctuating magnetic field Bₑ(t) which varies the qubit energy splitting.

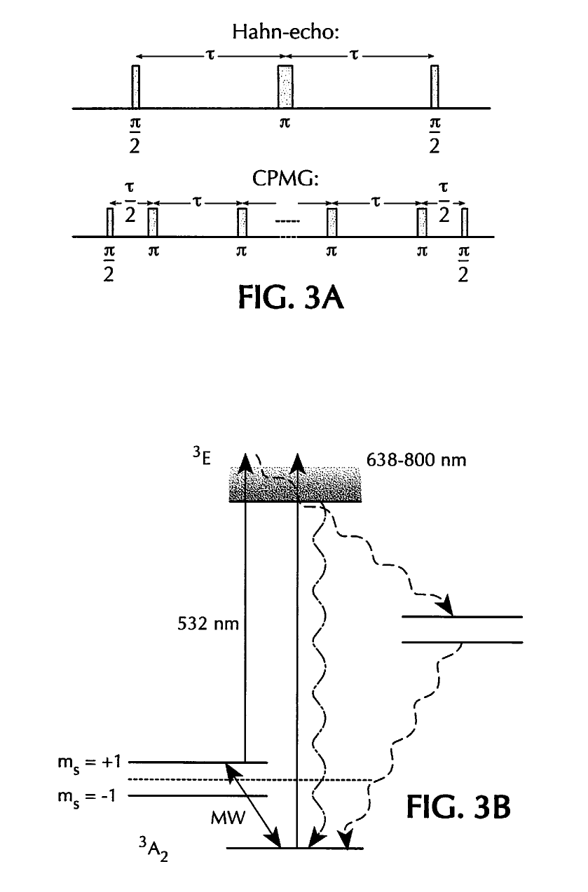

FIG. 3A shows two multi-pulse spin-control sequences: the Hahn-echo pulse sequence, and the multi-pulse (CPMG) pulse sequence. As seen in FIG. 3A, the CPMG pulse sequence is an extension of the Hahn-echo sequence, also well known, with n equally spaced π-pulses applied to the system after initially rotating it into the x axis with a π/2-pulse.

FIG. 3B illustrates the electronic energy level structure of the negatively charged NV center. As seen in FIG. 3B, the NV center has an electronic spin-triplet ground state with a zero-magnetic-field splitting 22.87 GHz between the mₛ=0 and mₛ=±1 spin states, quantized along the NV axis. A small external magnetic field applied along this axis lifts the degeneracy of the mₛ=±1 energy levels with a Zeeman shift ≈2.8 GHz.

Optical transitions between the electronic ground and excited states have a characteristic zero-phonon line at 637 nm, although 532 nm light is typically used to drive excitation to a phonon-sideband, and NV centers fluoresce at room temperature over a broad range of wavelengths that is roughly peaked around 700 nm. Optical cycling transitions between the ground and excited states are primarily spin conserving. There exists, however, a decay path that preferentially transfers the mₛ=±1 excited state population to the mₛ=0 ground-state through a metastable singlet state, without emitting a photon in the fluorescence band. It is this decay channel that allows the NV center's spin-state to be determined from the fluorescence signal, and also leads to optical pumping into the mₛ=0 ground-state.

In the present application, spectral decomposition methods and systems are described that can be used to characterize the dynamics of the composite solid-state spin bath, consisting of both electronic spin (N) and nuclear spin (¹³C) impurities. These methods can be used to study diamond samples with different NV densities and impurity spin concentrations, measuring both NV ensembles and single NV centers.

Because of coupling of the NV spins to their magnetic environment, as shown in FIG. 2B, coherence is lost over time with the general form C(t)=e^{-χ(t)}, where the functional χ(t) describes the time dependence of the decoherence process. In the presence of a modulation acting on the NV spins, for example a resonant microwave pulse sequence as described above, the decoherence functional is given by:

$$χ ( t ) = \frac{1}{π} {\int }_{0}^{∞} d ω S ( ω ) \frac{{F}_{t} ( ω )}{{ω}^{2}} ,$$

where S(ω) is the spectral function describing the coupling of the system to the environment. The modulation acting on the spins can be described by a filter function in the frequency domain Fᵣ(ω), as further described below.

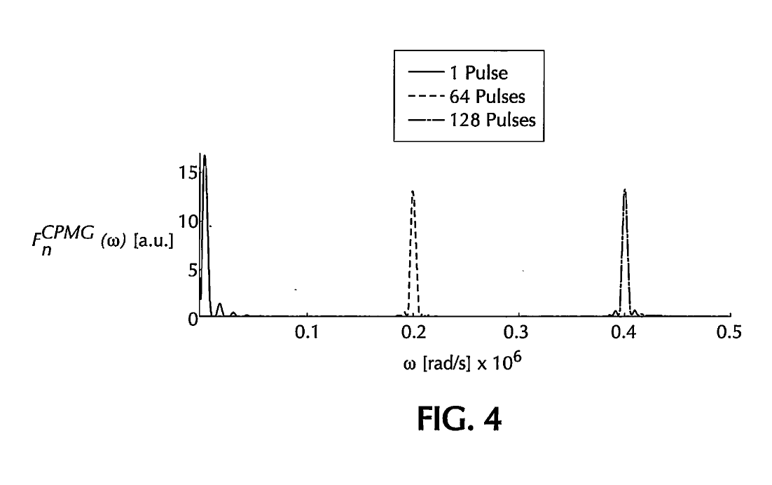

FIG. 4 illustrates the calculated F_{ω}^{CPMG} filter functions, for three different values of the number n of CPMG pulses, namely n=1, 64, and 128. The above equation for χ(t) holds in the approximation of weak coupling of the NV spins to the environment, which is appropriate for systems with dominantly electronic spin baths, such as the case with the diamond samples discussed in this application.

S(ω) can be determined from straightforward decoherence measurements of the NV spin qubits using a spectral decomposition technique. As seen from equation (1), if an appropriate modulation is applied to the NV spins such that Fₜ(ω)/(ω²t)=δ(ω−ω₀), that is, if a Dirac δ-function is localized at a desired frequency ω₀, then the decoherence functional can be written as:

χ(t)=t S(ω₀)/π.

Therefore, by measuring the time dependence of the qubit coherence C(t) when subjected to such a spectral δ-function modulation, the spin bath's spectral component at frequency ω₀ can be extracted:

S(ω₀)=−πln(C(t))/t.

The above-described procedure can then be repeated for different values of ω₀, so as to provide a complete spectral decomposition of the spin bath environment.

In one or more embodiments, a close approximation to the ideal spectral filter function Fₜ(ω) described above can be provided by a variation on the well-known CPMG pulse sequence for dynamical decoupling of a qubit from its environment.

In one or more embodiments, a deconvolution procedure can be applied to correct for deviations of the filter function from the ideal Dirac δ-function. The coherence of a two-level quantum system can be related to the magnitude of the off-diagonal elements of the system's density matrix. Specifically, NV electronic spin qubits in a finite external magnetic field can be treated as effective two-level spin systems with quantization (z) axis aligned with the NV axis. When the NV spins are placed into a coherent superposition of spin eigenstates, for example, aligned with the x axis of the Bloch sphere, the measureable spin coherence is given by C(t)=Tr[p(t)Sₓ].

The filter function for the n-pulse CAMG control sequence F_{CPMG}(ω) covers a narrow frequency region, which is centered at ω₀=πn/t, and is given by:

$${F}_{n}^{CPMG} ( ω t ) = 8 {sin}^{2} ( \frac{ω t}{2} ) \frac{{sin}^{4} ( \begin{matrix}ω t \\ 4 n\end{matrix} )}{{cos}^{2} ( \begin{matrix}ω t \\ 2 n\end{matrix} )} .$$

In some embodiments, the spin-bath spectrum is well described by a Lorentzian spectral function. The composite solid-state spin environment in diamond is dominated by a bath of fluctuating N electronic spin (S=½) impurities, which causes decoherence of the probed NV electron-spin qubits through magnetic dipolar interactions. In the regime of low external magnetic fields and room temperature (relevant to the present experiments), the N bath spins are randomly oriented, and their flip-flops or spin-state exchanges can be considered as random uncorrelated events. Therefore, the resulting spectrum of the N bath's coupling to the NV spins can be assumed to be Lorentzian:

$$S ( ω ) = \frac{{Δ}^{2} {τ}_{C}}{π} \frac{1}{1 + {( {ωτ}_{C} )}^{2}} .$$

The above-described Lorentzian spin-bath spectrum is characterized by two parameters, Δ and τ_{c}. Δ is the average coupling strength of the N bath to the probed NV spins, and τ_{c} is the correlation time of the N bath spins with each other, which is related to their characteristic flip-flop time.

The coupling strength Δ is given by the average dipolar interaction energy between the bath spins and the NV spins, and the correlation time τ_{c} is given by the inverse of the dipolar interaction energy between neighbouring bath-spins. Such spin-spin interactions scale as 1/r³, where r is the distance between spins. Thus, the coupling strength Δ is expected to scale as the N bath spin density nₛₚᵢₙ, i.e. Δ∝nₛₚᵢₙ. The correlation time t is expected to scale as the inverse of this density, i.e. τ_{c}∝nₛₚᵢₙ.

The multi-pulse CPMG sequence used in the above-described spectral decomposition methods can extend the NV spin coherence lifetime by suppressing the time-averaged coupling to the fluctuating spin environment. In general, the coherence lifetime T₂ increases with the number of pulses n used in the CPMG sequence. For a Lorentzian bath, in the limit of very short correlation times (τ_{c} much less than T₂), the sequence is inefficient and T₂∝n° (no improvement with number of pulses). In the opposite limit of very long correlation times (τ_{c} much greater than T₂), the scaling is T₂∝n^{2 3}.

In one or more embodiments, the above-described spectral decomposition methods may be applied experimentally to study the spin-bath dynamics and resulting scaling of T₂ with n for NV centers in diamond.

As described in conjunction with FIGS. 1A and 1B, the mₛ=0 to mₛ=±1 spin manifold of the NV triplet electronic ground state can be manipulated experimentally, using a static magnetic field and resonant MW pulses, and using a 532-nm laser to initialize and provide optical readout of the NV spin states. Specifically, the NV spins may be optically initialized to mₛ=0, then CPMG pulse sequences are applied with varying numbers of π-pulses n and with varying free precession times T. The NV spin state may then be measured using optical readout to determine the remaining NV multi-spin coherence. Finally, the measured coherence may then be used to extract the corresponding spin-bath spectral component Sₙ(ω) as described above.

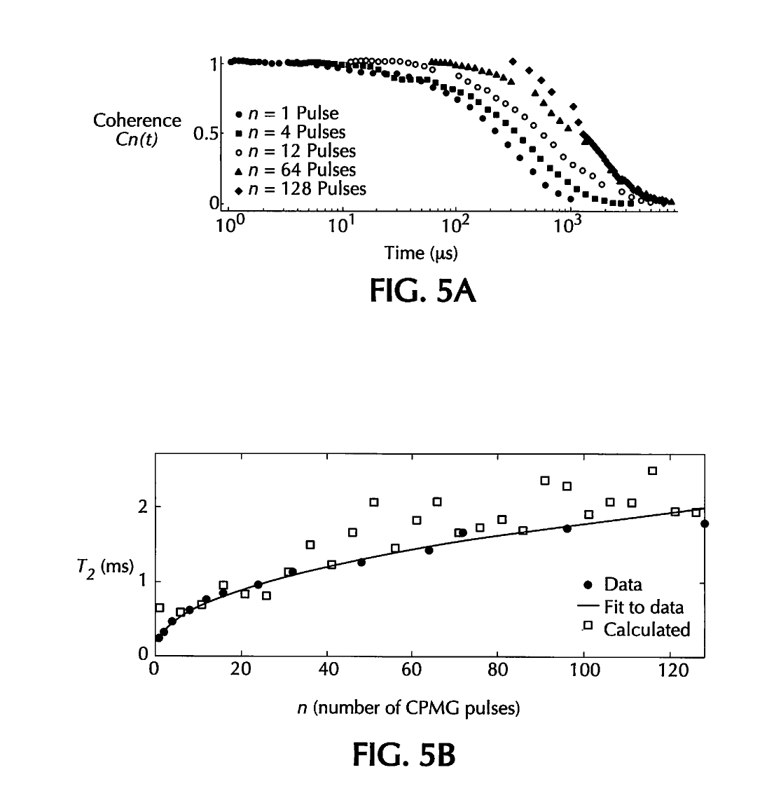

FIGS. 5A and 5B illustrate some results obtained using the methods described above. FIG. 5A shows examples of the measured NV multi-spin coherence decay Cₙ(t) as a function of pulse sequence duration t for CPMG pulse sequences with different numbers of π-pulses n. The measured C(t) are well described by a stretched exponential,

$${e}^{- {( t / {T}_{2} )}^{p}} ,$$

which is consistent with an electronic spin bath described by a Lorentzian spectrum.

FIG. 5B illustrates the scaling of T₂ with the number n of CPMG pulses, as derived from NV spin coherence decay data Cₙ(t). The NV multi-spin coherence lifetime T₂, determined from the measured coherence decay Cₙ(t), is plotted as a function of the number n of CPMG π-pulses.

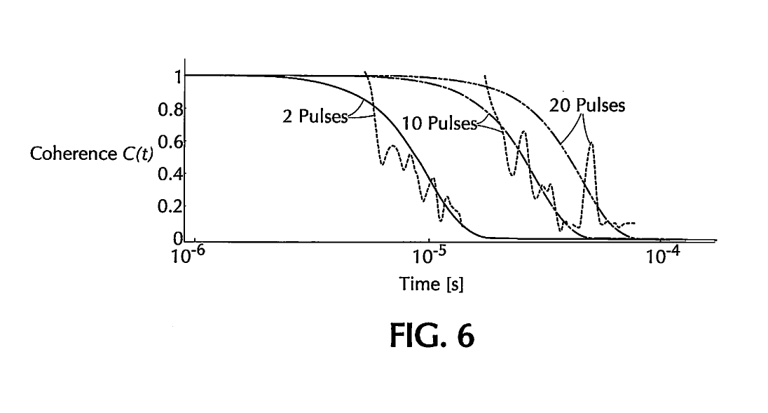

FIG. 6 compares some examples of measured NV multi-spin coherence as a function of time Cₙ(t) for CPMG pulse sequences with different numbers of pulses n, shown as solid lines, with corresponding synthesized curves calculated using the average-fit Lorentzian spin bath spectrum, shown in dots.

In some embodiments, the above-described spectral decomposition methods and systems can be used to extract the spin-bath parameters Δ and τ_{c}, as well as the NV multi-qubit coherence T₂ and FOM. In one embodiment, one sample that was an isotopically pure ¹²C diamond sample grown by chemical vapor deposition was studied. This sample has a very low concentration of ¹³C nuclear spin impurities (0.01%), a moderate concentration of N electronic spin impurities (˜1 p.p.m.), and a moderate NV density (−10¹⁴(cm⁻³)). The sample was studied using the NV wide-field microscope described in FIG. 1A.

The NV decoherence data was analyzed using the spectral decomposition methods outlined above, to extract the best-fit Lorentzian spin-bath spectrum, fit to the average of all data points. This analysis yielded a coupling strength of Δ=30±10 kHz, and a correlation time τ_{c}=10±15 μs. These results agree well with the range of values that were found for the Lorentzian spin-bath spectra S(ω) fit to each CPMG pulse sequence individually, Δ≈30 to 50 kHz and τ≈5 to 15 μs. These values are in reasonable agreement with the expected ‘N dominated bath’ values for Δ and τ_{c} for this sample's estimated concentrations of ¹³C and N spins, indicating that N electronic spin impurities are the dominant source of NV decoherence.

In summary, coherent spectroscopic methods and systems have been disclosed, which can be used to characterize the dynamics of the composite solid-state spin environment of NV color centers in room temperature diamond. These spectral decomposition methods and systems are based on well-known pulse sequences and a reconstruction algorithm, and can be applied to other composite solid-state spin systems, such as quantum dots and phosphorus donors in silicon. These types of measurements can provide a powerful approach for the study of many-body dynamics of complex spin environments, potentially exhibiting non-trivial effects related to the interplay between nuclear and electronic spin baths.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

Nothing that has been stated or illustrated is intended to cause a dedication of any component, step, feature, object, benefit, advantage, or equivalent to the public. While the specification describes particular embodiments of the present disclosure, those of ordinary skill can devise variations of the present disclosure without departing from the inventive concepts disclosed in the disclosure.

While certain embodiments have been described, it is to be understood that the concepts implicit in these embodiments may be used in other embodiments as well. In the present disclosure, reference to an element in the singular is not intended to mean “one and only one” unless specifically so stated, but rather “one or more.” All structural and functional equivalents to the elements of the various embodiments described throughout this disclosure, known or later come to be known to those of ordinary skill in the art, are expressly incorporated herein by reference.

What is claimed is:

1. A method comprising:
applying a sequence of spin-control modulation pulses to electronic spin impurities in a solid-state spin system; and
extracting a spectral content of a spin bath that surrounds the electronic spin impurities within the solid-state spin system, by measuring the coherent evolution and associated decoherence of the spin impurities as a function of number of the applied modulation pulses, and the time-spacing between the pulses.

2. The method of claim 1, wherein the act of measuring the coherent evolution and associated decoherence of the spin impurities comprises:
defining a time-dependent coherence function C(t)=e^{χ(t)} to represent the coherence of spin impurities within the solid-state spin system, where χ(t) is a decoherence functional that describes the decoherence of the spin impurities as a function of time; and
measuring the time-dependent coherence function C(t)=e^{-χ(t)} so as to extract a spectral component S(ω₀) of the composite solid-state spin system at the frequency ω₀.

3. The method of claim 2, wherein the modulation pulse sequence has a modulation waveform described in a frequency domain by a filter function Fₜ(ω) that is mathematically related to the decoherence functional by:
$$χ ( t ) = \frac{1}{π} {\int }_{0}^{∞} d ω S ( ω ) \frac{{F}_{t} ( ω )}{{ω}^{2}} ,$$
where S(ω) is a spectral function describing coupling of the spin impurities to a spin bath environment of the composite solid-state spin system.

4. The method of claim 1, wherein the act of extracting the spectral content at a desired frequency ω₀ comprises subjecting the spin impurities to a spectral δ-function modulation, with an ideal filter function Fₜ(ω) with a Dirac delta function localized at ω=ω₀, so that the spectral content of the spin bath at the desired frequency ω₀ is given by
S(ω₀)=πln(C(t))/t
and the ideal filter function Fₜ(ω) is mathematically represented by:
Fₜ(ω)/(ω^{L}t)=δ(ω−ω₀)

5. The method of claim 4, further comprising repeating, for a number of different frequencies ω=ωᵢ, i=1 . . . n, the acts of subjecting the spin impurities to spectral S-function modulations with the Dirac delta function localized at each frequency co, so as to extract the spectral content S(ω) at all of the different frequencies ω=ωᵢ, i=1 . . . n to obtain a broad range of spectral decomposition for the spin bath.

6. The method of claim 3, further comprising:
approximating the delta function in the filter function TWO at a frequency slightly different from am, then extracting a spectral component S(ω₀) of the composite solid-state spin system at the slightly different frequency.

7. The method of claim 6, wherein the modulation pulse sequence is an n-pulse CPMG sequence; and wherein a mathematical formula for the filter function for the n-pulse CPMG sequence is:
$${F}_{n}^{CPMG} ( ω t ) = 8 {sin}^{2} ( \frac{ω t}{2} ) \frac{{sin}^{4} ( \begin{matrix}ω t \\ 4 n\end{matrix} )}{{cos}^{2} ( \begin{matrix}ω t \\ 2 n\end{matrix} )} .$$

8. The method of claim 7, wherein the modulation pulse sequence is an n-pulse XY sequence.

9. The method of claim 1, wherein the solid state system is a diamond crystal, the spin impurities are NV centers in the diamond crystal.

10. The method of claim 9, wherein the spin bath environment in the diamond crystal is dominated by fluctuating N(nitrogen atom) electronic spin impurities so as to cause decoherence of the NV centers through magnetic dipolar interactions.

11. The method of claim 10, wherein the N spins of the spin bath are randomly oriented, and wherein the act of extracting the spectral content of the spin bath comprises extracting a Lorentzian spectrum of the N spin bath's coupling to the NV centers, given by:
$$S ( ω ) = \frac{{Δ}^{2} {τ}_{C}}{π} \frac{1}{1 + {( ω {τ}_{C} )}^{2}} ,$$
where Δ is the average coupling strength of the N bath to the NV spin impurities, and where τ_{c} is the correlation time of the N bath spins with each other.

12. The method of claim 11, further comprising the act of determining the values of A and T_{c} from the extracted spectrum S(ω).

13. A system comprising:
a microwave pulse generator configured to generate a sequence of spin-control modulation pulses and to apply the pulses to a sample containing electronic spin impurities in a solid-state spin system; and
a processing system configured to measure the coherent evolution and associated decoherence of the electronic spin impurities as a function of the number of the applied pulses and the time-spacing between the pulses, so as to extract a spectral content of a spin bath that surrounds the electronic spin impurities within the solid-state spin system.

14. The system of claim 13, wherein the electronic spin impurities comprise NV (nitrogen-vacancy) centers, and wherein the solid-state spin system comprises a diamond crystal.

15. The system of claim 13, wherein the spin-bath environment comprises ¹³C nuclear spin impurities and N electronic spin impurities within the diamond crystal.

16. The system of claim 13, further comprising an optical system, including an optical source configured to generate excitation optical pulses that initialize and read out the spin states of the spin impurities, when applied to the sample.

17. The system of claim 16, wherein the optical source is a laser tunable to a frequency of about 532 nm.

18. The system of claim 16, wherein the processing system comprises a computer-controlled digital delay generator coupled to the optical source and the microwave source and configured to control the timing of the microwave pulses and the optical pulses.

19. The system of claim 16, further comprising a detector configured to detect output radiation from the NV centers after the microwave pulses and the optical pulses have been applied thereto.

20. The system of claim 16, wherein the optical system further comprises an acousto-optic modulator configured to time the optical pulses so as to prepare and read out the NV spin states.

21. The system of claim 19, wherein the optical system further includes at least one of:
a dichroic filter configured to separate fluorescent radiation generated by the NV centers in response the excitation optical pulses; and
an objective configured to collect the fluorescent radiation generated by the NV centers in response to the excitation optical pulses and directed the collected fluorescence to the detector.

22. The system of claim 13, wherein the solid state system is a diamond crystal, the spin impurities are NV centers in the diamond crystal, and the spin bath environment in the diamond crystal is dominated by fluctuating N(nitrogen atom) electronic spin impurities, so that the spectrum of the N spin bath's coupling to the NV centers is a Lorentzian spectrum given by:
$$S ( ω ) = \frac{{Δ}^{2} {τ}_{C}}{π} \frac{1}{1 + {( {ωτ}_{C} )}^{2}} .$$
where Δ is the average coupling strength of the N bath to the NV spin impurities, and where τ_{c} is the correlation time of the N bath spins with each other.

23. The system of claim 22, wherein the processing system is further configured to determine the values of Δ and τ_{c} from the extracted spectrum S(ω).

24. The system of claim 13, wherein the electronic spin impurities comprise phosphorus donors, and wherein the solid-state spin system comprises silicon.

25. The system of claim 13, wherein the modulation pulse sequence comprises at least one of:
an n-pulse CPMG sequence; and
an n-pulse XY sequence.
